(19) United States
(12) Patent Application Publication
(10) Pub. No.: US 2026/0204073 A1
(43) Pub. Date: Jul. 16, 2026

(54) IMAGE PROVIDING APPARATUS AND IMAGE PROVIDING METHOD

(71) Applicant: TOYOTA JIDOSHA KABUSHIKI KAISHA, Toyota-shi (JP)

(72) Inventors: Kazuhito ESHIMA, Toyota-shi (JP); Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/406,069

(22) Filed: Dec. 2, 2025

(30) Foreign Application Priority Data
Jan. 15, 2025 (JP) 2025-005577

(51) Int. Cl. G06V 20/52; G06T 11/00; G06V 20/58

(52) U.S. Cl. CPC G06V 20/52; G06T 11/00; G06V 20/586

(57) ABSTRACT

The image providing apparatus provides the user with an image of a target vehicle for automatic valet parking, and comprises a first memory, a second memory, and a processor. The first memory is configured to store a first image related to the target vehicle captured by one or more on-board cameras of the target vehicle. The second memory is configured to store a second image related to the target vehicle captured by a plurality of monitoring cameras installed in the parking lot where automatic valet parking is performed. The processor is configured to execute a plurality of instructions. The plurality of instructions is configured to cause the processor to execute generating a display image to be shown to the user based on at least one of the first image and the second image according to the situation of the target vehicle and displaying the display image on a user terminal.

### CROSS-REFERENCE TO RELATED APPLICATION

The present application claims priority under 35 U.S.C. §119 to Japanese Patent Application No. 2025-005577, filed on January 15, 2025, the contents of which application are incorporated herein by reference in their entirety.

### BACKGROUND

### Technical Field

The present disclosure relates to an image providing apparatus and an image providing method for providing a user with an image of a target vehicle for automatic valet parking.

### Background Art

DE102012222562A1 discloses a system that performs automatic valet parking using an on-board camera mounted on a vehicle and monitoring cameras installed on walls and pillars of a parking lot. Furthermore, JP2019-156298A discloses a vehicle remote operation device that displays an image captured by an on-board camera mounted on the vehicle on a user terminal.

One of the concerns for users of automatic valet parking is whether the entrusted vehicle can safely travel automatically within the parking lot without colliding with or scraping against other vehicles or walls. As a method to reassure users who have such concerns, it is conceivable to enable users to view images of vehicles traveling within the parking lot on their user terminals. As one example, the technology disclosed in JP2019-156298A for displaying images from an on-board camera on a user terminal can be cited.

However, it is not enough for users to simply be able to view images of vehicles in motion. Depending on the image displayed on the user terminal, it may alleviate the user's concerns and provide great relief, or conversely, it may fail to alleviate the user's concerns and instead make the user feel uneasy.

### SUMMARY

The present disclosure has been made in view of the above-mentioned problems. One object of the present disclosure is to provide an image providing apparatus and an image providing method capable of giving a sense of security to a user who has entrusted a vehicle to automatic valet parking.

According to one embodiment of the present disclosure, a first image providing apparatus for achieving the above-mentioned object is provided. The first image providing apparatus is an apparatus that provides the user with an image of a target vehicle for automatic valet parking, and comprises a first memory, a second memory, and a processor communicatively coupled to the first memory and the second memory, which are configured as follows. The first memory is configured to store a first image related to the target vehicle captured by one or more on-board cameras of the target vehicle. The second memory is configured to store a second image related to the target vehicle captured by a plurality of monitoring cameras installed in the parking lot where automatic valet parking is performed. The processor is configured to execute a plurality of instructions. The plurality of instructions is configured to cause the processor to execute generating a display image to be shown to the user based on at least one of the first image and the second image according to the situation of the target vehicle and displaying the display image on a user terminal.

In one embodiment of the present disclosure, the plurality of instructions may be configured to cause the processor to further execute evaluating the risk for the target vehicle to continue driving and generating the display image according to the situation and the risk of the target vehicle. Furthermore, the plurality of instructions may be configured to cause the processor to further execute performing processing on the display image for privacy protection of vehicles or persons existing around the target vehicle. Furthermore, the plurality of instructions may be configured to cause the processor to further execute obtaining an image request from the user and generating the display image according to the situation of the target vehicle and the image request. In one embodiment of the present disclosure, generating the display image may include generating a composite image by combining the first image and the second image according to the situation of the target vehicle.

According to one embodiment of the present disclosure, a first image providing method for achieving the above-mentioned object is provided. A first image providing method is a method for providing the user with an image of a target vehicle for automatic valet parking, and includes the following first to fourth steps. The first step is to obtain a first image related to the target vehicle captured by one or more on-board cameras of the target vehicle. The second step is to obtain a second image related to the target vehicle captured by a plurality of monitoring cameras installed in the parking lot where automatic valet parking is performed. The third step is to generate a display image to be shown to the user based on at least one of the first image and the second image according to the situation of the target vehicle. The fourth step is to display the display image on a user terminal.

According to one embodiment of the present disclosure, a first program is provided for achieving the above-mentioned object. The first program is a program that can be stored in a non-transitory computer readable medium and includes a plurality of instructions for causing a computer processor to execute the first image providing method including the first to fourth steps described above.

According to one embodiment of the present disclosure, a second image providing apparatus is provided for achieving the above-mentioned object. The second image providing apparatus is a device that provides the user with an image of a target vehicle for automatic valet parking, and comprises a first memory, a second memory, and a processor communicably coupled to the first memory and the second memory, which are configured as follows. The first memory is configured to store a first image related to the target vehicle captured by one or more on-board cameras of the target vehicle. The second memory is configured to store a second image related to the target vehicle captured by a plurality of monitoring cameras installed in the parking lot where automatic valet parking is performed. The processor is configured to execute a plurality of instructions. The plurality of instructions is configured to cause the processor to execute generating a composite image by combining the first image and the second image and displaying the composite image on a user terminal.

According to one embodiment of the present disclosure, a second image providing method for achieving the above-mentioned object is provided. The second image providing method is a method for providing the user with an image of a target vehicle for automatic valet parking, comprising the following first to fourth steps. The first step is to obtain a first image related to the target vehicle captured by one or more on-board cameras of the target vehicle. The second step is to obtain a second image related to the target vehicle captured by a plurality of monitoring cameras installed in the parking lot where automatic valet parking is performed. The third step is to generate a composite image by combining the first image and the second image. The fourth step is to display the composite image on a user terminal.

According to one embodiment of the present disclosure, a second program is provided to achieve the above-mentioned object. The second program is a program that can be stored in a non-transitory computer readable medium and includes a plurality of instructions for causing a computer processor to execute the second image providing method including the first to fourth steps described above.

In one embodiment of the present disclosure, according to the first image providing apparatus, the first image providing method, and the first program, an image of a vehicle during automatic valet parking is obtained from both an on-board camera and a monitoring camera. A display image to be shown to the user is generated based on the situation of the vehicle, and the generated display image is displayed on a user terminal. During automatic valet parking, the user is concerned about the vehicle in motion and its surroundings. What the user is concerned about varies depending on the situation of the vehicle, so it is not easy and troublesome for the user to select an image that satisfies the user from among the images that can be displayed. According to the first image providing apparatus, the first image providing method, and the first program, an image suitable for the user to visually recognize what the user is concerned about can be automatically generated and displayed on the user terminal, thereby providing a sense of security to the user.

In one embodiment of the present disclosure, according to the second image providing apparatus, the second image providing method, and the second program, an image of the vehicle during automatic valet parking is obtained from both an on-board camera and a monitoring camera, the images from the on-board camera and the monitoring camera are composed, and the composite image is displayed on a user terminal. The on-board camera image and monitoring camera image each have areas that are clearly visible and areas that are not clearly visible or difficult to see, and these two types of images have a complementary relationship. Therefore, with either one of the images, the user may not be able to see the desired area, potentially leaving the user's concerns unresolved. According to the second image providing apparatus, the second image providing method, and the second program, the images from the on-board camera and the monitoring camera, which complement each other, are composed. This allows the user to visually confirm what the user is concerned about in the composite image, thereby providing the users with a sense of security.

### BRIEF DESCRIPTION OF THE DRAWINGS

FIG. 1 is a diagram illustrating an overview of the configuration of an image providing system.

FIG. 2 is a diagram illustrating the hardware configuration of the image providing system.

FIG. 3 is a diagram illustrating the flow of information within the image providing system.

FIG. 4 is a flowchart illustrating a series of processes executed by a processor of the image providing apparatus.

### DETAILED DESCRIPTION

### 1. Configuration of Image Providing System

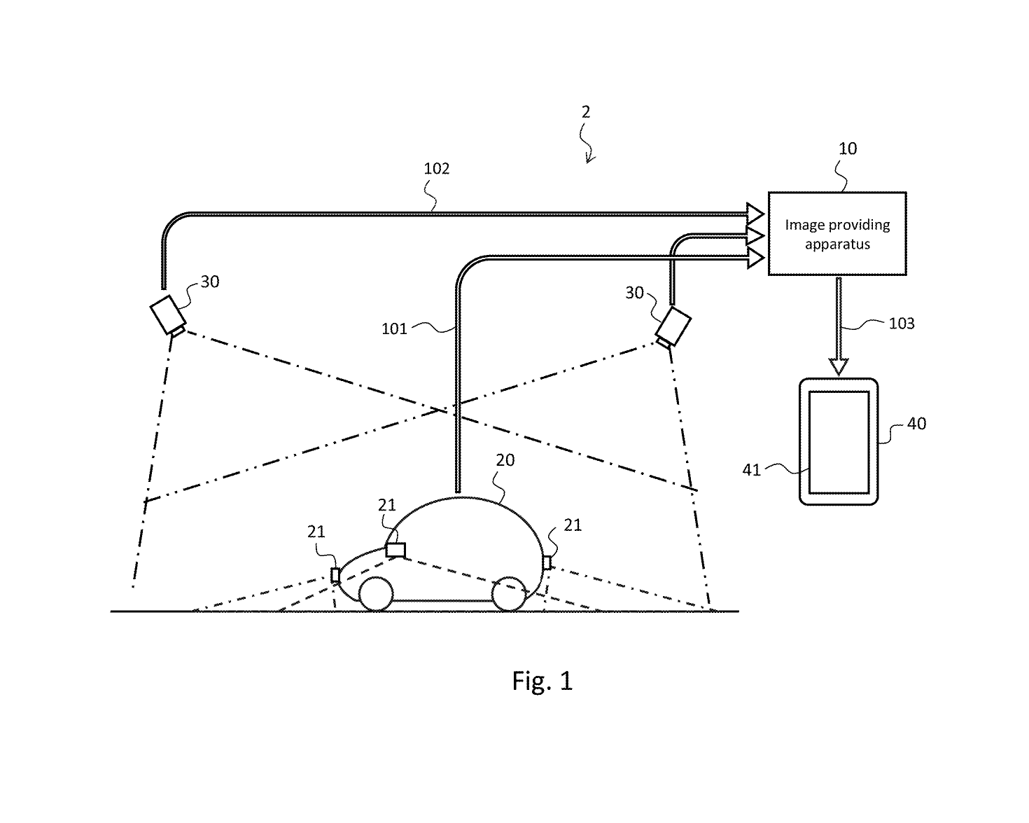

FIG. 1 is a diagram illustrating an overview of the configuration of an image providing system 2 according to the present embodiment. The image providing system 2 is introduced in a parking lot that provides automatic valet parking, and is a system that provides users with images of vehicles 20 left in the parking lot, particularly images of vehicles 20 traveling within the parking lot.

The vehicle 20 is a target vehicle for automatic valet parking, equipped with the necessary functions for automatic valet parking, including an autonomous driving function. The autonomous driving of the vehicle 20 within the parking lot is controlled, for example, by a vehicle management system utilizing monitoring cameras 30. Alternatively, the autonomous driving of the vehicle 20 may be controlled through cooperation between a vehicle management system and a control system mounted on the vehicle 20. The vehicle 20 may be an autonomous driving vehicle capable of autonomously traveling outside the parking lot.

The image providing system 2 includes a plurality of on-board cameras 21 installed in the vehicle 20. The on-board cameras 21 are cameras for a multi-around view monitor installed in the interior of the vehicle 20. The on-board cameras 21 are arranged as a set, with cameras installed at the front, rear, and on both side mirrors of the vehicle 20. The on-board cameras 21 may include cameras for an Advanced Driver Assistance System (ADAS).

The image providing system 2 includes a plurality of monitoring cameras 30 installed in the parking lot. The monitoring cameras 30 are arranged along the travel route of the vehicle 20 within the parking lot. During autonomous driving by automatic valet parking, the vehicle 20 enters the imaging range of at least one monitoring camera 30. The monitoring camera 30 is positioned at a high location such as a ceiling, wall, or pillar, and captures an image of the vehicle 20 from above. The angle of the monitoring camera 30 may be adjusted to capture an image of the vehicle 20 directly from above, or it may be adjusted to capture images from a diagonal front, diagonal rear, or diagonal side angle.

The image providing system 2 includes at least one image providing apparatus 10. The image providing apparatus 10 obtains an on-board camera image (first image) 101 related to the vehicle 20 captured by the on-board camera 21. Furthermore, the image providing apparatus 10 obtains a monitoring camera image (second image) 102 related to the vehicle 20 captured by the monitoring camera 30. The image providing apparatus 10 generates a display image 103 based on at least one of the on-board camera image 101 and the monitoring camera image 102.

The image providing system 2 includes a user terminal 40 possessed by the user who has parked the vehicle 20 in the parking lot. The display image 103 generated by the image providing apparatus 10 is transmitted to the user terminal 40. The user terminal 40 is, for example, a smartphone with an application installed that has the function of displaying the display image 103. The display image 103 is shown on the display screen 41 of the user terminal 40.

Among the elements constituting the image providing system 2, the monitoring camera 30 switches to another monitoring camera 30 depending on the position of the vehicle 20 in the parking lot. Since the on-board camera 21 and the user terminal 40 are associated with the vehicle 20, when the vehicle 20 subject to automatic valet parking changes, the on-board camera 21 and the user terminal 40 that constitute the image providing system 2 also change to a different on-board camera 21 and user terminal 40. In the image providing system 2, only the image providing apparatus 10 exists as a fixed and unchanging element.

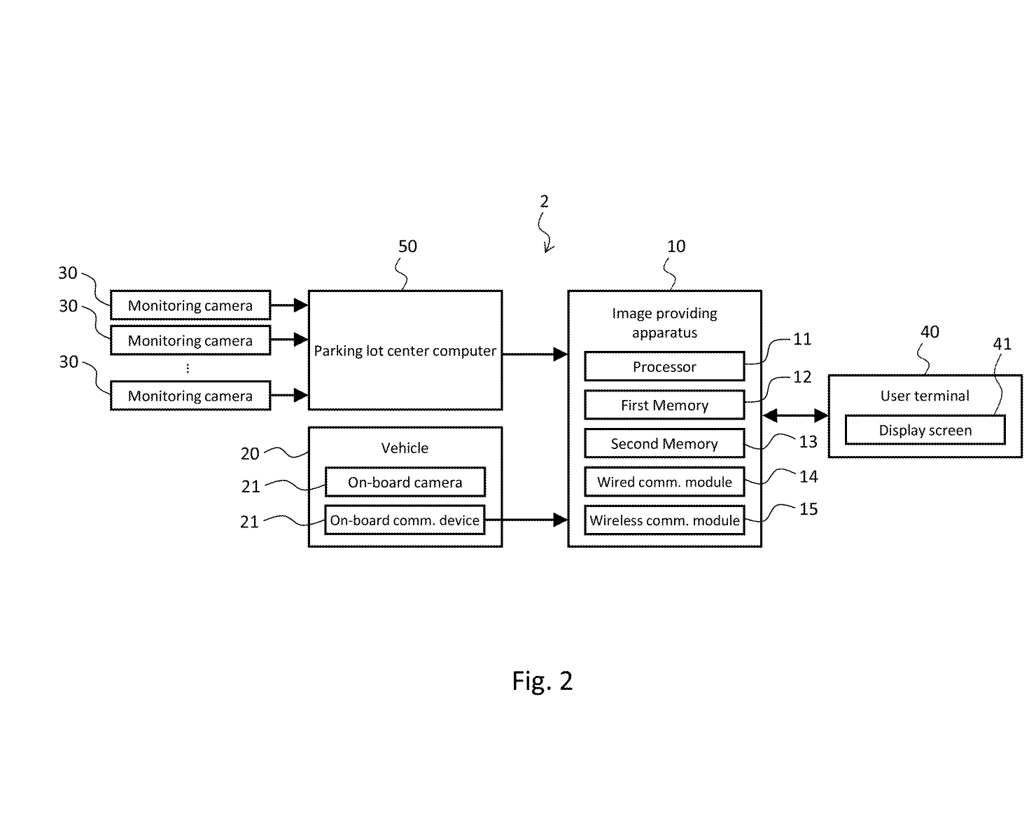

FIG. 2 is a diagram illustrating the hardware configuration of the image providing system 2. The image providing apparatus 10 and each monitoring camera 30 are connected via a wired LAN through a parking lot center computer 50. The image providing apparatus 10 and the on-board camera 21 are connected via a wireless LAN through an on-board communication device 22 equipped in the vehicle 20. The image providing apparatus 10 and the user terminal 40 are connected via a mobile network over the Internet. Two-way communication is conducted between the image providing apparatus 10 and the user terminal 40.

The image providing apparatus 10 is a computer that constitutes an automatic valet parking system. The image providing apparatus 10 may be the same computer as the vehicle management system that performs driving control of the vehicle 20 using the monitoring camera 30, or it may be a separate computer.

The image providing apparatus 10 comprises a processor 11. The processor 11 is a processing circuit that performs various types of processing including image processing and arithmetic processing. Examples of the processor 11 include CPU, GPU, TPU, NPU, FPGA, ASIC, DSP, and combinations thereof. The processor 11 is communicatively coupled to other components of the image providing apparatus 10. The image providing apparatus 10 has a program memory (not shown), and when the image providing program stored in the program memory is executed by the processor 11, the computer functions as the image providing apparatus 10.

The image providing apparatus 10 comprises one or more memories. The memories comprised in the image providing apparatus 10 include a first memory 12 and a second memory 13. The first memory 12 is a memory that stores on-board camera images obtained from the vehicle 20. The second memory 13 is a memory that stores monitoring camera images obtained from the parking lot center computer 50. The first memory 12 and the second memory 13 are, for example, FIFO (First-In-First-Out) memories. The first memory 12 and the second memory 13 may be physically separate memories, or they may be different storage areas allocated in one or more memories.

The image providing apparatus 10 comprises a wired communication module 14 and a wireless communication module 15. The wired communication module 14 is used for communication with the parking lot center computer 50 via a wired LAN. Additionally, the wired communication module 14 is also used for communication with the user terminal 40 via the Internet. The wireless communication module 15 is used for communication with the on-board communication device 22 using a wireless LAN.

### 2. Processing Executed in Image Providing System

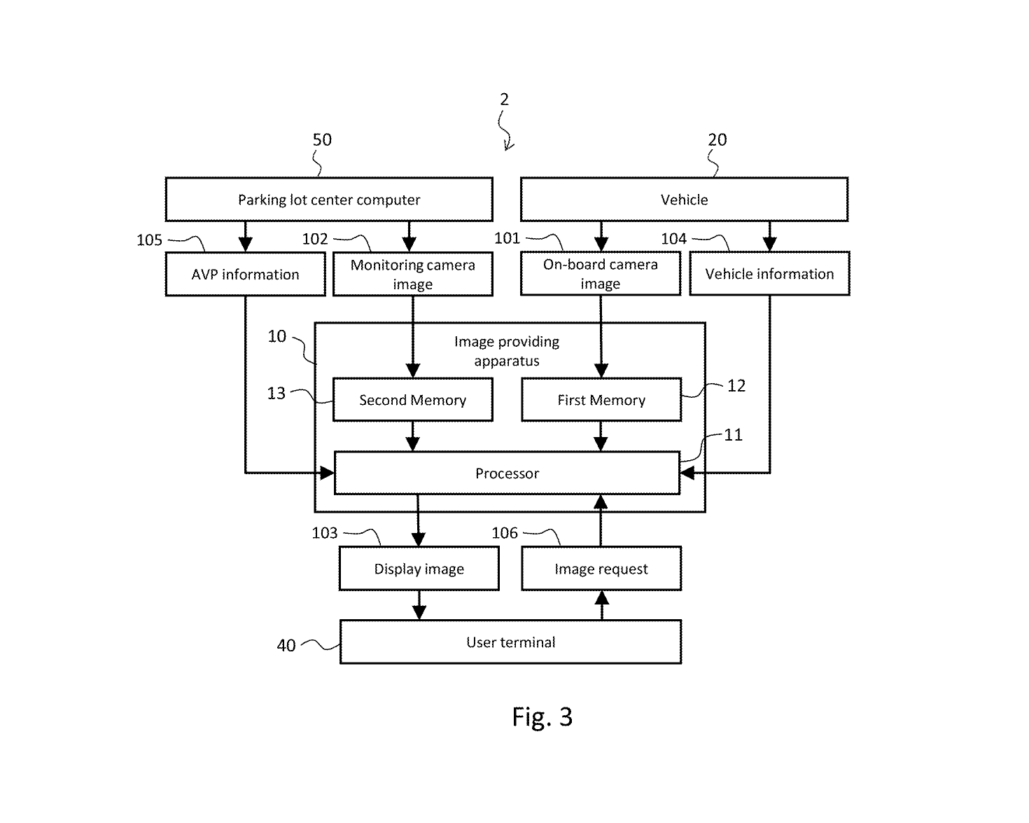

FIG. 3 is a diagram illustrating the flow of information within the image providing system 2. The processing executed in the image providing system 2 will be explained using this figure.

The vehicle 20 transmits the on-board camera image 101 and vehicle information 104 to the image providing apparatus 10. The vehicle information 104 includes information related to the motion of the vehicle 20, such as vehicle speed, acceleration, and steering angle, which are obtained by sensors mounted on the vehicle 20.

The parking lot center computer 50 transmits the monitoring camera image 102 and automatic valet parking (AVP) information 105 to the image providing apparatus 10. The AVP information 105 includes information necessary for automatic valet parking, such as position information of the vehicle 20, route information, vehicle type information, site map information, and obstacle information including other vehicles. The position information is information related to the position of the vehicle 20 within the parking lot, which is recognized by the monitoring camera 30. The route information is information related to the route within the parking lot along which the vehicle 20 automatically travels during automatic valet parking. The vehicle type information is information related to the vehicle type, including specifications of the vehicle 20 such as the vehicle width and vehicle length. The site map information is information related to a map showing the layout of roads and facilities within the parking lot. The obstacle information is information related to objects that could be obstacles for the vehicle 20 to travel along the route, and objects that could cause accidents such as collisions. Such objects include pillars, walls, parked other vehicles, and moving other vehicles.

In the image providing apparatus 10, the on-board camera image 101 is stored in the first memory 12, and the monitoring camera image 102 is stored in the second memory 13. The processor 11 generates a display image 103 based on the on-board camera image 101 stored in the first memory 12 and the monitoring camera image 102 stored in the second memory 13. Examples of the display image 103 include a top-view image or an oblique top-view image generated from the on-board camera image 101, an image obtained by enlarging or reducing the monitoring camera image 102 to match the size of the vehicle 20, an image obtained by transforming the viewpoint of the monitoring camera image 102, and a composite image created by combining the on-board camera image 101 and the monitoring camera image 102. In generating the display image 103, the processor 11 refers to the vehicle information 104 and the AVP information 105.

The processor 11 determines the situation of the vehicle 20 based on the AVP information 105. Examples of the situation of the vehicle 20 include the vehicle 20 being in motion, the vehicle 20 about to enter an intersection, the vehicle 20 passing through an intersection, and the vehicle 20 having just started moving from a parking space.

The processor 11 evaluates the risk of the vehicle 20 based on the vehicle information 104 and the AVP information 105. The risk of the vehicle 20 referred to here is the risk associated with the continued operation of the vehicle 20, for example, the risk of the vehicle 20 being scratched by hitting or rubbing against other vehicles or walls during automatic valet parking. Examples of indicators representing the types and magnitudes of risks for the vehicle 20 include TTC (Time To Collision with obstacles such as walls or stationary vehicles), vehicle speed, longitudinal or lateral acceleration, road gradient, and gaps with surrounding objects. The risk of a vehicle 20 increases as the TTC becomes smaller, as the vehicle speed becomes higher, as the longitudinal or lateral acceleration becomes greater, as the road gradient becomes steeper, and as the gaps with the surrounding objects become smaller.

The processor 11 generates the display image 103 in accordance with the situation of the vehicle 20. For example, when the vehicle 20 travels on a straight road with no obstacles in the vicinity, the processor 11 generates an image of the vehicle 20 and its surroundings looking down from a predetermined direction from the monitoring camera image 102, and sets it as the display image 103. For example, when the vehicle 20 enters the parking slot while reversing, the processor 11 generates an image capturing the vicinity of the rear and side of the vehicle 20 from the on-board camera image 101 and sets it as the display image 103. Furthermore, for example, when the vehicle 20 passes through an intersection, the processor 11 generates an image capturing the front and both sides of the vehicle 20, and sets it as the display image 103. This image may be generated from the monitoring camera image 102, or it may be a composite image of the on-board camera image 101 and the monitoring camera image 102. Furthermore, for example, when the vehicle 20 turns a corner with a small R (radius), the processor 11 generates an image that shows the distance between the vehicle 20 and objects existing on the inside of the corner, and sets it as the display image 103. This image may be an image generated from the monitoring camera image 102, an image generated from the on-board camera image 101, or a composite image of these.

Furthermore, the processor 11 generates the display image 103 according to the risk of the vehicle 20. For example, when a vehicle 20 is traveling on a straight road and the gap between the vehicle and an object on the left side becomes narrower than the gap between the vehicle and an object on the right side, the processor 11 switches the display image 103 from an image looking down from a predetermined direction at the vehicle 20 and its surroundings, generated from the monitoring camera image 102, to an image focusing on the left side of the vehicle 20, generated from the on-board camera image 101. The image focusing on the left side of the vehicle 20 may be a composite image of the on-board camera image 101 and the monitoring camera image 102. Furthermore, for example, when the vehicle 20 is entering the parking slot while reversing, the processor 11 may use the image generated from the monitoring camera image 102 as the display image 103 until the TTC to an object in the rear becomes less than or equal to a predetermined value. When the TTC to the object in the rear becomes less than or equal to the predetermined value, the processor 11 may switch the display image 103 to the image generated from the on-board camera image 101. However, in the generation of the display image 103, the condition of the vehicle 20 may be considered as a mandatory condition, while the risk of the vehicle 20 may be treated as an optional condition.

The composition of the on-board camera image 101 and the monitoring camera image 102 by the processor 11 includes complementing blind spots of the on-board camera image 101 with the monitoring camera image 102 and complementing blind spots of the monitoring camera image 102 with the on-board camera image 101. Furthermore, the composition of the on-board camera image 101 and the monitoring camera image 102 also includes creating a 3D spatial image by combining the on-board camera image 101 and the monitoring camera image 102. As methods for creating the 3D spatial image, various techniques can be used, such as multi-view stereo method, Structure from Motion (SfM), or deep learning-based 3D reconstruction method. Furthermore, the composite image generated by the processor 11 includes an image in which the monitoring camera image 102 is spliced into the on-board camera image 101. In addition, the composite image generated by the processor 11 includes a picture-in-picture image in which either the on-board camera image 101 or the monitoring camera image 102 is displayed within the other.

The processor 11 generates the display image 103 in response to an image request 106 from the user terminal 40. The image request 106 may be a request for simply requesting image transmission, or it may be a request regarding the content of the image. However, the content requested in the image request 106 is of a rough content, such as an image showing the vehicle 20 from above or an image showing the vehicle 20 from the side. The processor 11 determines the detailed content of the display image 103 according to the situation of the vehicle 20, or according to the situation and the risk of the vehicle 20.

Additionally, the processor 11 performs image processing for privacy protection on the display image 103. Such image processing includes applying mosaic processing to license plates of surrounding vehicles, the surrounding vehicles themselves, or surrounding persons captured in the monitoring camera image 102.

The display image 103 generated by the processor 11 is a real-time image. However, since the user may desire to replay, the image providing apparatus 10 may be equipped with a recording and playback function. In this case, the display image 103 transmitted from the image providing apparatus 10 to the user terminal 40 becomes a recorded image stored in the image providing apparatus 10. The user can specify a playback period of the recorded image in the application on the user terminal 40.

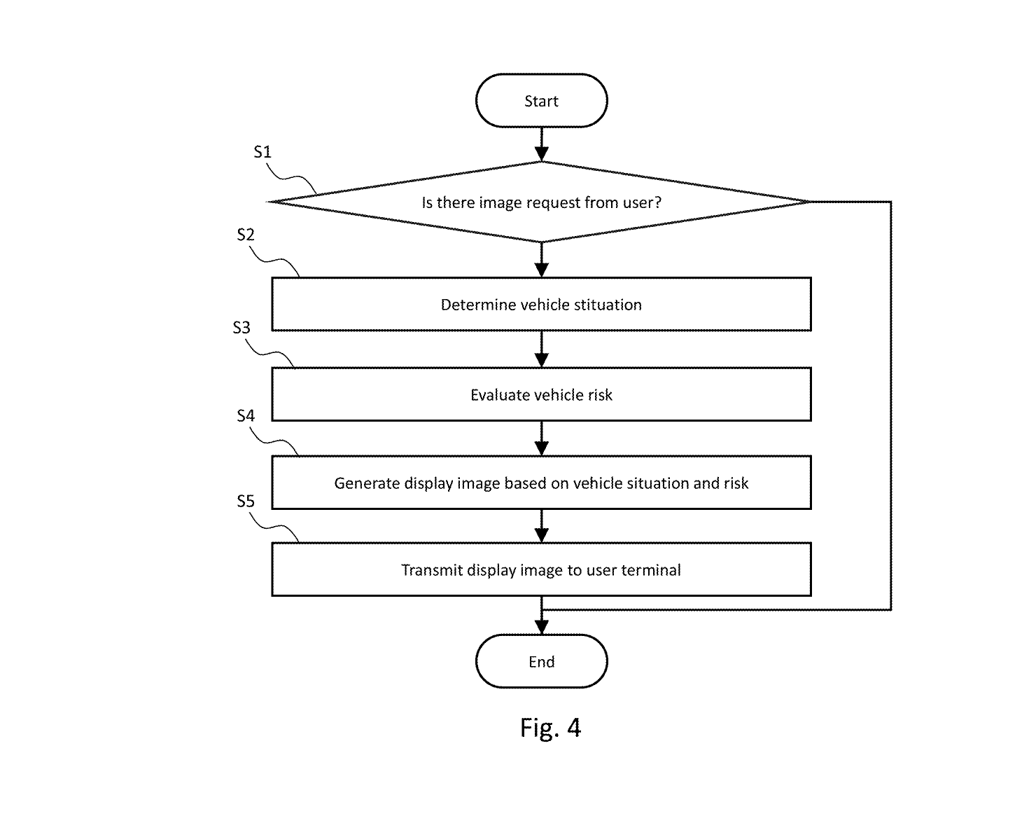

FIG. 4 is a flowchart illustrating a series of processes executed by the image providing system 2, particularly by the processor 11. This flowchart also illustrates the image providing method according to the present embodiment. The image providing program stored in the program memory includes a plurality of instructions for causing the processor 11 to execute the image providing method shown in this flowchart.

In step S1 of this flowchart, the processor 11 determines whether the image request 106 has been received from the user. Until the image request 106 is received, the processor 11 skips the processes of steps S2-S5 and terminates the flow. Then, upon receiving the image request 106, the processor 11 executes the process of step S2.

In step S2, the processor 11 first identifies the vehicle 20 associated with the user terminal 40 based on the user terminal information included in the image request 106. The association between the user terminal 40 and the vehicle 20 is established at the time of registration for use of the parking lot. The processor 11 obtains the AVP information 105 of the identified vehicle 20 from the parking lot center computer 50, and determines the situation of the vehicle 20 based on the AVP information 105. After executing the process of step S2, the processor 11 executes the process of step S3.

In step S3, the processor 11 obtains the vehicle information 104 from the vehicle 20 and evaluates the risk of the vehicle 20 based on the vehicle information 104 and the AVP information 105. After executing the process of step S3, the processor 11 executes the process of step S4. It should be noted that the process of step S3 and the process of step S2 may be executed in reverse order or in parallel. Furthermore, since the risk evaluation of the vehicle 20 is optional, the process of step S3 may be omitted, and the process of step S4 may be executed after the execution of the process of step S2.

In step S4, the processor 11 generates the display image 103 based on at least one of the on-board camera image 101 stored in the first memory 12 and the monitoring camera image 102 stored in the second memory 13. The processor 11 generates the display image 103 according to the situation of the vehicle 20, or according to the situation and risk of the vehicle 20. After executing the process of step S4, the processor 11 executes the process of step S5.

In step S5, the processor 11 transmits the display image 103 generated in step S4 to the user terminal 40. When the user sends a new image request 106, for example, requesting an image with a changed viewpoint direction, the processor 11 executes the processes of steps S2-S5 again and transmits the display image 103 generated according to the current situation of the vehicle 20, or according to both the current situation and risk of the vehicle 20, to the user terminal 40.

### 3. Effects of Image Providing System

During automatic valet parking, the user is concerned about the vehicle 20 in motion and its surroundings. Since what the user is concerned about varies depending on the situation of the vehicle 20, it is neither easy nor convenient for the user to select a satisfactory image from the available images. In this regard, according to the image providing system 2, a image suitable for visually recognizing what the user is concerned about is automatically generated as the display image 103 and displayed on the user terminal 40. As a result, the user can obtain a sense of security.

Furthermore, the on-board camera image 101 and the monitoring camera image 102 each have areas that are clearly visible and areas that are not clearly visible or difficult to see, and the two are complementary to each other. Therefore, with either one of the images alone, the user may not be able to see the desired areas, potentially leaving the user's concerns unresolved. In this regard, according to the image providing system 2, the on-board camera image 101 and the monitoring camera image 102, which are in a complementary relationship, are composed, and the user can visually recognize what the user is concerned about in the composite image. As a result, the user can obtain a sense of security.

What is claimed is:

1. An image providing apparatus for providing a user with an image of a target vehicle for automatic valet parking, comprising:
a first memory configured to store a first image related to the target vehicle captured by one or more on-board cameras of the target vehicle;
a second memory configured to store a second image related to the target vehicle captured by a plurality of monitoring cameras installed in a parking lot where the automatic valet parking is performed; and
a processor communicably coupled to the first memory and the second memory, and configured to execute a plurality of instructions,
wherein the plurality of instructions is configured to cause the processor to execute:
generating a display image to be shown to the user based on at least one of the first image and the second image according to a situation of the target vehicle; and
displaying the display image on a user terminal.

2. The image providing apparatus according to claim 1, wherein the plurality of instructions is configured to cause the processor to further execute:
evaluating a risk for the target vehicle to continue driving; and
generating the display image according to the situation and the risk.

3. The image providing apparatus according to claim 1, wherein the generating the display image includes generating a composite image by combining the first image and the second image according to the situation.

4. The image providing apparatus according to claim 1, wherein the plurality of instructions is configured to cause the processor to further execute performing processing on the display image for privacy protection of vehicles or persons existing around the target vehicle.

5. The image providing apparatus according to claim 1, wherein the plurality of instructions is configured to cause the processor to further execute:
obtaining an image request from the user; and
generating the display image in accordance with the situation and the image request.

6. An image providing method for providing a user with an image of a target vehicle for automatic valet parking, the method comprising:
obtaining a first image related to the target vehicle captured by one or more on-board cameras of the target vehicle;
obtaining a second image related to the target vehicle captured by a plurality of monitoring cameras installed in a parking lot where the automatic valet parking is performed;
generating a display image to be shown to the user based on at least one of the first image and the second image according to a situation of the target vehicle; and
displaying the display image on a user terminal.

7. A non-transitory computer readable medium storing a program including a plurality of instructions for causing a processor of a computer to execute the image providing method according to claim 6.

8. An image providing apparatus for providing a user with an image of a target vehicle for automatic valet parking, comprising:
a first memory configured to store a first image related to the target vehicle captured by one or more on-board cameras of the target vehicle; and
a second memory configured to store a second image related to the target vehicle captured by a plurality of monitoring cameras installed in a parking lot where the automatic valet parking is performed; and
a processor communicably coupled to the first memory and the second memory, and configured to execute a plurality of instructions,
wherein the plurality of instructions is configured to cause the processor to execute:
generating a composite image by combining the first image and the second image; and
displaying the composite image on a user terminal.
